(19) United States
(12) Patent Application Publication
(10) Pub. No.: US 2015/0178648 A1
(43) Pub. Date: Jun. 25, 2015

(54) PEER-TO-PEER NETWORKING

(71) Applicants: Shazi Iqbal, Danville, CA (US); Parvez Fatteh, Pleasanton, CA (US)

(72) Inventors: Shazi Iqbal, Danville, CA (US); Parvez Fatteh, Pleasanton, CA (US)

(21) Appl. No.: 14/217,450

(22) Filed: Mar. 17, 2014

Related U.S. Application Data
(60) Provisional application No. 61/802,437, filed on Mar. 16, 2013.

(51) Int. Cl. G06Q 10/06

(52) U.S. Cl. CPC G06Q 10/0639

(57) ABSTRACT

In one embodiment, a method of managing productivity with a peer-to-peer system is disclosed. The disclosed information handling system (IHS) may receive information from a particular user who may be a medical professional such as a doctor or other medical practitioner. In one embodiment, the IHS may include an information store, revenue tool, doctor referral tool, specialist referral tool, facility referral tool, consultation tool and a samples tool. The particular user may use the revenue tool of the IHS to view the predicted revenue of upcoming appointments in his or her schedule. The revenue tool of the IHS may predict the revenue of appointments by utilizing information from the information store of the IHS. These tools may automatically increase the revenue of the user by scheduling additional appointments and referring appointments to other medical professionals in the peer-to-peer network.

### CROSS REFERENCE TO RELATED PATENT APPLICATIONS

This patent application claims priority to Provisional U.S. Patent Application Ser. No. 61/802,437, filed Mar. 16, 2013, inventors Iqbal et al., entitled “MANAGEMENT AND PRODUCTIVITY TOOL WITH PEER-TO-PEER (P2P) INTERACTION”, the disclosure of which is incorporated herein by reference in its entirety.

### BACKGROUND

The disclosures herein relate generally to information handling systems (IHSs), and more specifically, to IHSs that communicate with other IHSs. Multiple IHSs may be connected together via communication networks and/or the Internet to communicate and/or share information. Productivity tools are desirable for the users of IHSs to increase their efficiency and productiveness.

### BRIEF SUMMARY

In one embodiment, a method of enhancing productivity in a peer-to-peer networking system is disclosed. The method includes receiving, by a revenue tool of an information handling system (IHS), input information including a current appointment schedule of a particular user, proficiencies of the particular user, and preferences of the particular user from an information store. The method also includes determining, by the revenue tool of the IHS, a predicted revenue for the particular user for a predetermined period of time in response to the input information. The method also includes testing to determine, by the revenue tool of the IHS, if the predicted revenue associated with the current schedule meets a target revenue threshold. The method further includes accessing, by the revenue tool of the IHS, alternative tools that potentially increase the predicted revenue of the particular user, the alternative tools being accessed if the predicted revenue associated with the current schedule does not meet the target revenue threshold. The method still further includes transmitting, by the alternative tools, optional scheduling information to the revenue tool, the optional scheduling information including scheduling options. The method also includes determining, by the revenue tool of the IHS, revenue associated with each of the scheduling options of the option scheduling information. The method further includes modifying, by the revenue tool of the IHS, the current appointment schedule of the particular user in response to the option scheduling information if the scheduling options associated therewith provide increased revenue, thus providing a modified appointment schedule. The method still further includes displaying, by the revenue tool of the IHS, the modified appointment schedule of the particular user in response to the modifying step.

In another embodiment, an information handling system (IHS) is disclosed. The IHS includes a processor and a memory coupled to the processor. The memory being is configured with a revenue tool that receive input information including a current appointment schedule of a particular user, proficiencies of the particular user, and preferences of the particular user from an information store. The revenue tool determines a predicted revenue for the particular user for a predetermined period of time in response to the input information. The revenue tool also tests to determine if the predicted revenue associated with the current schedule meets a target revenue threshold. The revenue tool also accesses alternative tools in the memory that potentially increase the predicted revenue of the particular user, the alternative tools being accessed if the predicted revenue associated with the current schedule does not meet the target revenue threshold. The alternative tools transmit optional scheduling information to the revenue tool, the optional scheduling information including scheduling options. The revenue tool also determines revenue associated with each of the scheduling options of the option scheduling information. The revenue tool also modifies the current appointment schedule of the particular user in response to the option scheduling information if the scheduling options associated therewith provide increased revenue, thus providing a modified appointment schedule. The revenue tool displays the modified appointment schedule of the particular user in response to the modifying the current appointment schedule.

In another embodiment, a revenue tool computer program product is disclosed that includes a non-transitory computer readable storage medium. The revenue tool computer program product includes first instructions that receive input information including a current appointment schedule of a particular user, proficiencies of the particular user, and preferences of the particular user from an information store. The revenue tool computer program product also includes second instructions that determine a predictive revenue for the particular user for a predetermined period of time in response to the input information. The revenue tool computer program product further includes third instructions that determine if the predicted revenue associated with the current schedule meets a target revenue threshold. The revenue tool computer program product still further includes fourth instructions that access alternative tools that potentially increase the predicted revenue of the particular user, the alternative tools being accessed if the predicted revenue associated with the current schedule does not meet the target revenue threshold. The revenue tool computer program product includes fifth instructions that transmit optional scheduling information to the revenue tool, the optional scheduling information including scheduling options. The revenue tool computer program product also includes sixth instructions that determine revenue associated with each of the scheduling options of the options scheduling information. The revenue tool further includes seventh instructions that modify the current appointment schedule of the particular user in response to the option scheduling information if the scheduling options associated therewith provide increased revenue, thus providing a modified appointment schedule. The revenue tool computer program product still further includes eighth instructions that display the modified appointment schedule of the particular user in response to modifying the current appointment schedule. The first, second, third, fourth, fifth, sixth, seventh and eighth instructions are stored on the non-transitory computer readable storage medium.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 is a block diagram showing one embodiment of the disclosed peer-to-peer management and productivity system.

FIG. 2 is a block diagram of an information handling system (IHS) that may be used in the disclosed peer-to-peer management and productivity system.

FIG. 3 is a flowchart that shows a representative process flow of a revenue tool that may be used in the disclosed peer-to-peer management and productivity system.

FIG. 4 is a flowchart that shows a representative process flow of a doctor referral tool that may be used in the disclosed peer-to-peer management and productivity system.

FIG. 5 is a flowchart that shows a representative process flow of a specialist referral tool that may be used in the disclosed peer-to-peer management and productivity system.

FIG. 6 is a flowchart that shows a representative process flow of a facility referral tool that may be used in the disclosed peer-to-peer management and productivity system.

FIG. 7 is a flowchart that shows a representative process flow of a consultation tool that may be used in the disclosed peer-to-peer management and productivity system.

FIG. 8 is a flowchart that shows a representative process flow of a samples tool that may be used in the disclosed peer-to-peer management and productivity system.

FIG. 9 is a representation of one embodiment of the disclosed peer-to-peer management and productivity system user interface on a display.

FIG. 10 is a flowchart that shows one embodiment of a representative process flow of a learning element of the revenue tool that may be used in the disclosed peer-to-peer management and productivity system.

FIG. 11 is a representation of the disclosed peer-to-peer management and productivity system including predicted revenue output of a particular user showing scheduled appointments and associated revenue over a span of time.

### DETAILED DESCRIPTION

The disclosed information handling system (IHS) may receive information from a particular user who may be a medical professional, such as a doctor or other medical practitioner. The user's IHS may take the form of a smart phone, tablet computer, personal digital assistant (PDA) or other computing device. In one embodiment, the IHS may include an information store, revenue tool, doctor referral tool, specialist referral tool, facility referral tool, consultation tool and a samples tool. The particular user, such as a medical professional, may use the revenue tool to view the predicted revenue associated with upcoming appointments in his or her schedule. The revenue tool of the IHS may predict the revenue associated with appointments by utilizing information from the information store of the IHS, as described in more detail below.

The revenue tool of the IHS may also utilize the doctor referral tool, specialist referral tool, facility referral tool, consultation tool, and samples tool to increase revenue by scheduling additional appointments in open time slots of the particular user's schedule as received from other medical professionals via the peer-to-peer networks. The revenue tool may also use the doctor referral tool, specialist referral tool, facility referral tool, consultation tool, and samples tool to generate revenue through an administrative fee for administrative expenses involved in utilizing the peer-to-peer networking system by referring patients or doctors (for previously scheduled consultations) to other doctors and/or specialists and/or facilities that don't generate enough revenue for a particular timeslot for the particular user and/or conflict with the user's working hour preferences and/or conflict with a higher revenue appointment. In one embodiment, the administrative fee may be paid to the company operating the peer-to-peer networking system, and is described in more detail below.

The revenue tool may also use the specialist referral tool to generate revenue by sharing facilities and fees for a particular appointment with a particular patient. For example, the specialist referral tool may allow the user to share his/her office with another doctor/specialist for an appointment and also share the associated fees. The consultation tool may allow doctors in the peer-to-peer network to consult with other doctors regarding a particular patient and diagnosis. The consultation tool may allow the user to search for, communicate with, and appropriately compensate or be compensated for the consultation.

The samples tool may prevent pharmaceutical representatives from decreasing the revenue of the particular user below a revenue threshold set by the user. Consuming too much of a doctor's time with pharmaceutical representatives appointments may decrease the doctor's revenue. The samples tool allows the user to schedule appointments with pharmaceutical representatives for pharmaceutical samples once a revenue threshold has been met. The samples tool may also be utilized not just by pharmaceutical representatives, but also by medical machine suppliers, and other entities that supply materials, equipment, devices and/or services. The samples tool methodology is not limited in scope by the pharmaceutical representative example above.

In one embodiment, the revenue tool executes several other tools. In other embodiments, the tools may be executed separately and/or by the user. In another embodiment, the doctor referral tool, specialist referral tool, facility referral tool, consultation tool, and samples tool may be utilized irrespective of the revenue tool. The user may designate particular appointments as “off-limits” to the revenue tool which may not be modified by the revenue tool. In other embodiments, patients may view available doctor schedules and schedule appointments using the peer-to-peer networking system.

Doctors, specialists, facilities, and pharmaceutical representatives may utilize the peer-to-peer network to communicate with messages from their respective information handling systems (IHSs). In other embodiments, doctors, specialists, facilities, and pharmaceutical representatives may utilize the peer-to-peer network to schedule “in-house” or “out-of-house” appointments for in-person meetings.

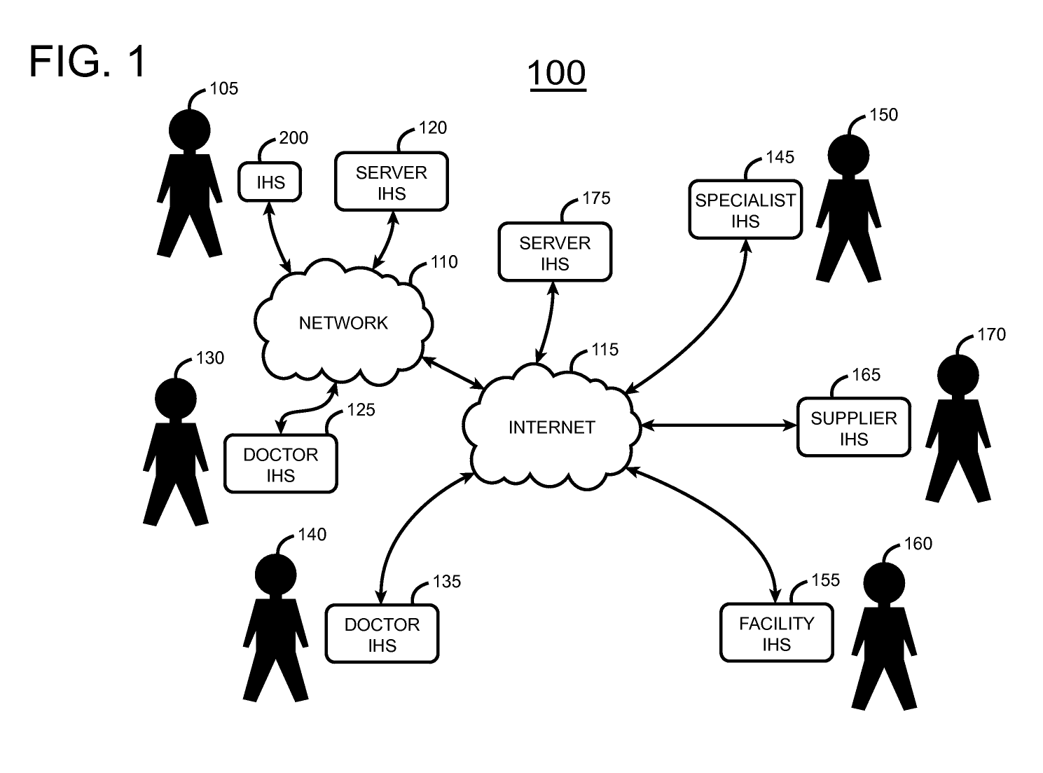

FIG. 1 is a block diagram showing one embodiment of the disclosed peer-to-peer networking management and productivity system 100. In one embodiment, user 105 may be a doctor or other medical professional. User 105 may utilize IHS 200 to manage productivity and revenue in a peer-to-peer environment. IHS 200 may couple via network 110 to the Internet 115 to communicate with other IHSs. Server IHS 120 may couple via network 110 to the Internet 115. In one embodiment, network 110 may be a local network at user 105's medical practice. Doctor IHS 125 may couple via network 110 to the Internet 115. Doctor 130 at user 105's medical practice may use doctor IHS 125. User 105 may communicate with doctor 130 via IHS 200, network 110, and doctor IHS 125.

Doctor IHS 135 may couple to the Internet 115. Doctor 140, not physically located at user 150's medical practice, may use doctor IHS 135 to communicate via the Internet 115. Specialist IHS 145 may couple to the Internet 115. Specialist 150, not physically located at user 150's medical practice, may use specialist IHS 145 to communicate via the Internet 115. Facility IHS 155 may couple to the Internet 115. Facility personnel 160, not physically located at user 150's medical practice, may use facility IHS 155 to communicate via the Internet 115. Pharmaceutical samples supplier IHS 165 may couple to the Internet 115. Pharmaceutical representative 170, not physically located at user 150's medical practice, may use pharmaceutical samples supplier IHS 165 to communicate via the Internet 115. Pharmaceutical samples supplier IHS 165 may also be referred to as samples IHS 165. Server IHS 175, not physically located at user 150's medical practice, may communicate via the Internet 115.

In one embodiment, the IHS 200 may include an information store, revenue tool, doctor referral tool, specialist referral tool, facility referral tool, consultation tool and a samples tool. In an alternative embodiment, IHS 200, server IHS 120, doctor IHS 125, doctor IHS 135, specialist IHS 145, facility IHS 155, supplier samples IHS 165, server IHS 175 may each include an information store, revenue tool, doctor referral tool, specialist referral tool, facility referral tool, consultation tool and a samples tool. In this embodiment, IHS 200, doctor IHS 125, doctor IHS 135, specialist IHS 145, facility IHS 155 and supplier samples IHS 165 may store data locally in their respective information stores and transmit changes to their respective information stores to the information store of server IHS 175 which acts as a master storage. In this manner, server IHS 175 may send the most updated information to other IHSs in the peer-to-peer network.

Server IHS 175 may propagate changes to its respective information store, i.e. updated information, to IHS 200, doctor IHS 125, doctor IHS 135, specialist IHS 145, facility IHS 155 and samples IHS 165. In some embodiments, particular offices may also employ a local server. For example, user 105's doctors' office employs server IHS 120 on the local office network 110. Server IHS 120 may also store, transmit, and update its information store as described above. In other embodiments, to follow HIPAA regulations, identifying patient data may only be stored locally. For example, the patient identifying information may be stored in the information store of server IHS 120 with respective identifiers, and the identifiers are transmitted to server IHS 175, without the patient identifying information.

In FIG. 1 the peer-to-peer networking productivity management system and referral network may be utilized by medical professionals. This is one illustrative embodiment of the peer-to-peer networking system methodologies. These peer-to-peer networking productivity management system methodologies may be used in other fields and are not limited by this disclosure. For example, the peer-to-peer networking productivity management system methodologies may also be used in the aerospace, culinary, and other fields.

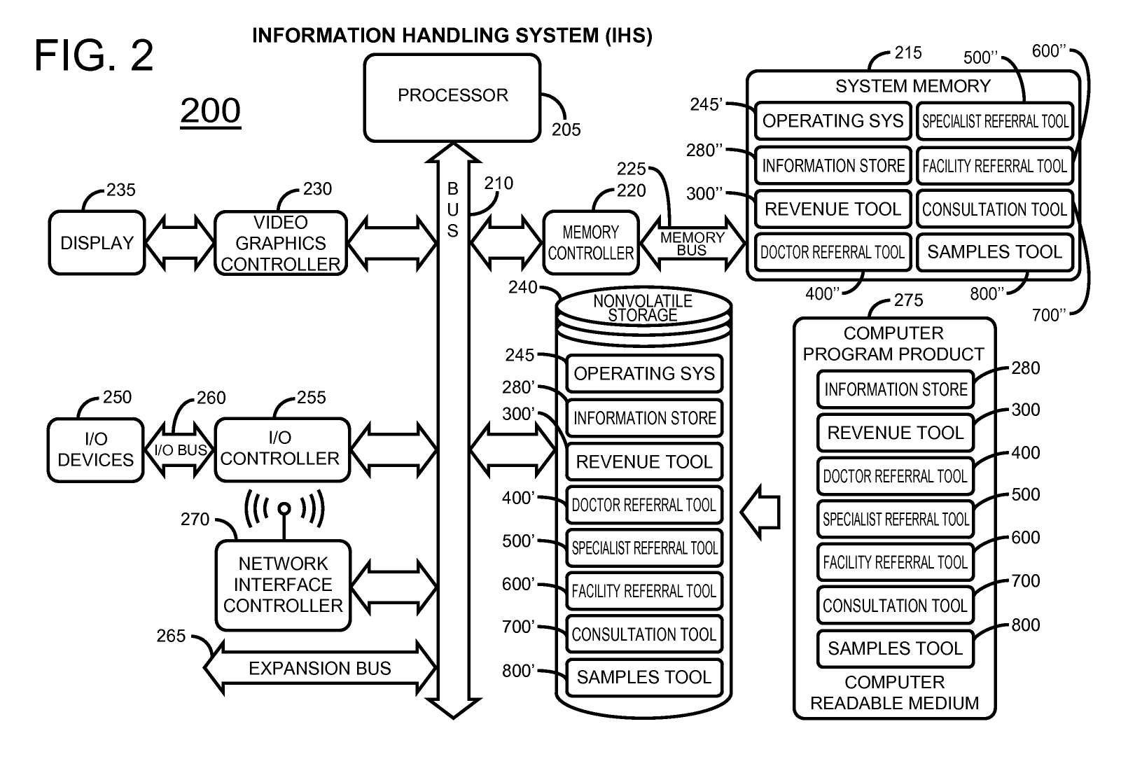

FIG. 2 is a block diagram of an information handling system (IHS) 200 that may be used in the disclosed system. IHS 200 includes a processor 205 that may include multiple cores. IHS 200 processes, transfers, communicates, modifies, stores or otherwise handles information in digital form, analog form or other form. IHS 200 includes a bus 210 that couples processor 205 to memory 215 via a memory controller 220 and memory bus 225. System memory 215 may also be referred to as main memory. System memory 215 may be a static random access memory (SRAM) array or a dynamic random access memory (DRAM) array. Processor 205 may also include local memory such as L1, L2 and L3 caches. A video graphics controller 230 couples display 235 to bus 210. Nonvolatile storage 240, such as a hard disk drive, solid-state drive (SSD), CD drive, DVD drive, or other nonvolatile storage couples to bus 210 to provide IHS 200 with permanent storage of information. System memory 215 and nonvolatile storage 240 are both forms of memory stores. Nonvolatile storage 240 stores an operating system 245 (OPERATING SYS) that governs operation of IHS 200. I/O devices 250, such as speakers, a keyboard and a pointing device, couple to bus 210 via I/O controller 255 and I/O bus 260.

One or more expansion busses 265, such as USB, IEEE 1394 bus, ATA, SATA, PCI, PCIE, DVI, HDMI and other busses, couple to bus 210 to facilitate the connection of peripherals and devices to IHS 200. A network interface controller (NIC) 270 couples to bus 210 to enable IHS 200 to connect by wire or wirelessly to a network and other information handling systems. NIC 270 may also be called a network communication adapter, network interface adapter, network adapter, network interface or an adapter. While FIG. 2 shows one IHS that employs processor 205, the IHS may take many forms. For example, IHS 200 may take the form of a desktop, portable, laptop, notebook, tablet or other form factor computer or data processing system. IHS 200 may take other form factors such as a gaming device, a personal digital assistant (PDA), a portable telephone device, a communication device or other devices that include a processor and memory.

IHS 200 includes a revenue tool computer program product 300, doctor referral tool computer program product 400, specialist referral tool computer program product 500, facility referral tool computer program product 600, consultation tool computer program product 700, and a samples tool computer program product 800 on digital media 275 such as a CD, DVD or other media. For simplicity, the terms revenue tool, doctor referral tool, specialist referral tool, facility referral tool, consultation tool, and samples tool will be used below, respectively. IHS 200 may store information store 280, revenue tool 300, doctor referral tool 400, specialist referral tool 500, facility referral tool 600, consultation tool 700, and samples tool 800 in nonvolatile storage 240 as information store 280′, revenue tool 300′, doctor referral tool 400′, specialist referral tool 500′, facility referral tool 600′, consultation tool 700′, and samples tool 800′, respectively. IHS 200 may also store operating system 245 (OPERATING SYS) in nonvolatile storage 240. When IHS 200 initializes, the IHS loads operating system 245 into system memory 215 for execution as operating system 245′. IHS 200 also loads information store 280′, revenue tool 300′, doctor referral tool 400′, specialist referral tool 500′, facility referral tool 600′, consultation tool 700′, and samples tool 800′ into system memory 215 for execution as information store 280″, revenue tool 300″, doctor referral tool 400″, specialist referral tool 500″, facility referral tool 600″, consultation tool 700″, and samples tool 800″, respectively.

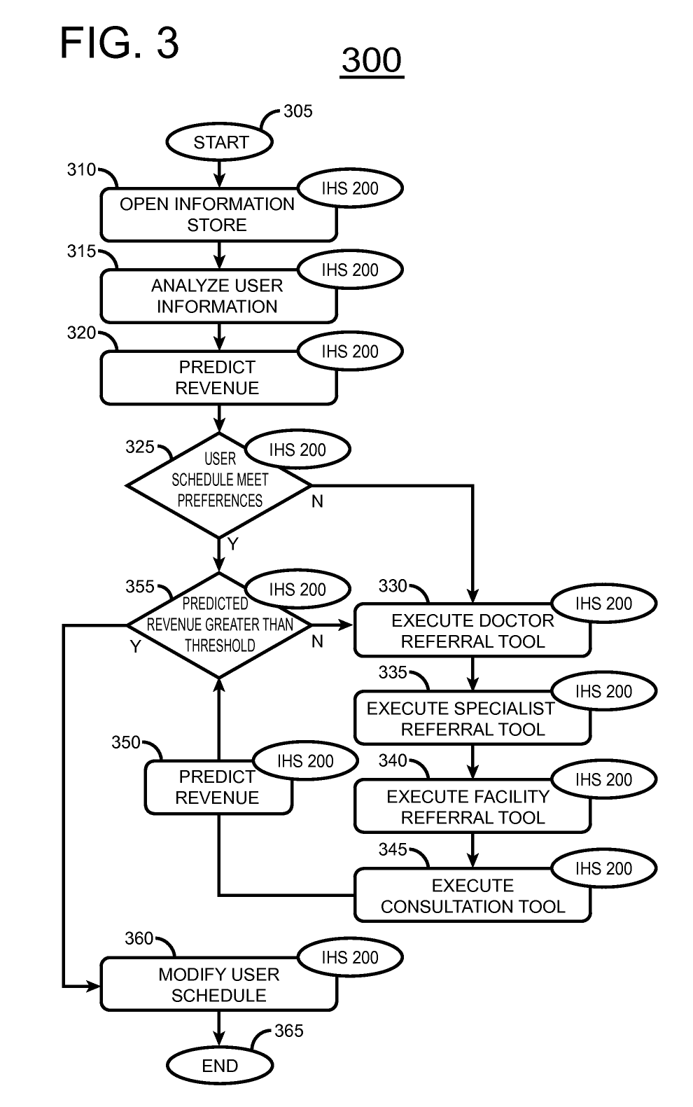

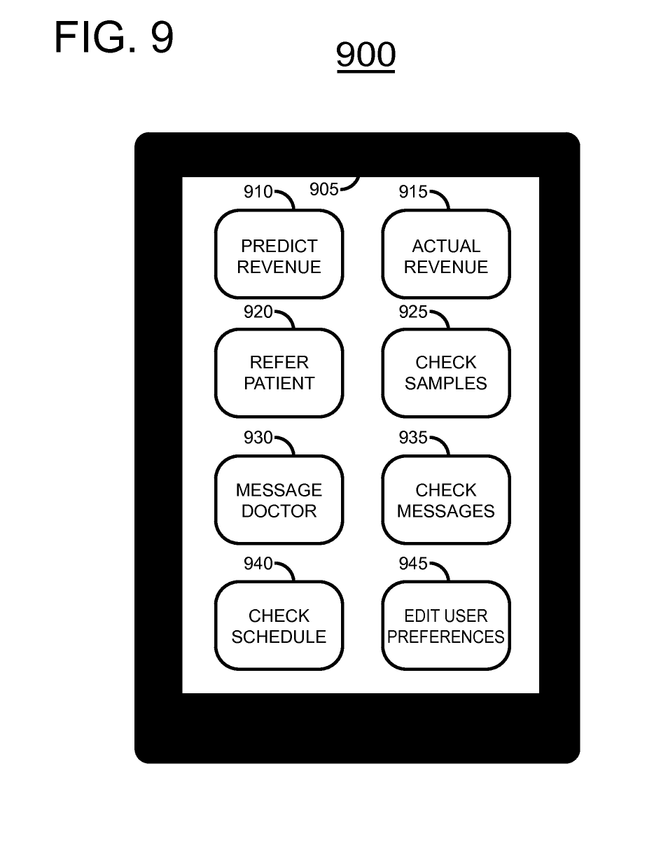

FIG. 3 is a flowchart that shows a representative process flow of a revenue tool 300 that executes on IHS 200. Process flow commences when IHS 200 is switched on, as per start block 305. In actual practice, the user may press a button on the user interface to initiate revenue tool 300, as shown in one embodiment in FIG. 9. Revenue tool 300 may open information store 280 to extract information needed by revenue tool 300, as per block 310. Revenue tool 300 may analyze user information stored from information store 280, as per block 315. User information may include information about the particular user 105, but may not be limited to, schedule, proficiencies and preferences. The schedule may include appointments and bookings for particular times on particular days.

In one embodiment, the appointments may include information associated with the appointment. Schedule information may include appointment times, appointment durations, patient identifying information, patient history, patient insurance information, disease classification codes and medical procedures associated with the disease classification codes. Proficiencies may include disease classification codes with which user 105 is proficient, medical procedures associated with the disease classification codes user 105 with which is proficient, as well as known languages, and specialties. Preferences may include preferred working hours, additional working hours, hours unable to work, accepted insurances and revenue threshold.

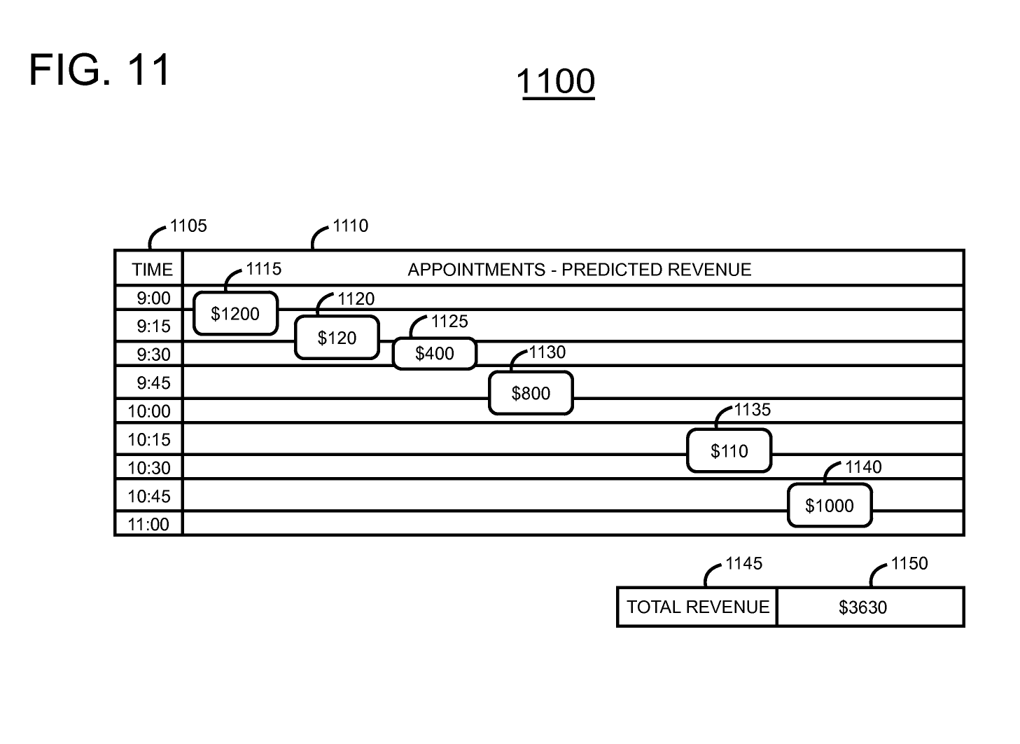

Revenue tool 300 may utilize the user information and other information from information store 280 to predict the revenue of user 105's schedule, as per block 320. In one embodiment, revenue tool 300 may calculate a predicted revenue for each appointment in the schedule utilizing the patient history, patient insurance information, disease classification codes, procedures associated with the disease classification codes, staff requirements associated with the medical procedures and disease classification codes, medical supply requirements associated with the medical procedures and disease classification codes, time requirements, and respective costs. Revenue tool 300 may display user 105's schedule with predicted revenue for a particular time period, as shown in FIG. 11 and described in more detail below.

Revenue tool 300 may determine that user 105's schedule does not match user 105's preferences, as per block 325. For example, user 105's schedule may include appointments at times not during user 105's working hours set in user 105's preferences. Revenue tool 300 may identify the conflicting appointments in user 105's schedule and utilize doctor referral tool 400, specialist referral tool 500, facility referral tool 600 and/or consultation tool 700 to ameliorate the conflict.

Revenue tool 300 may execute doctor referral tool 400, as per block 330. Doctor referral tool 400 may return a list of appointments referred to other doctors and associated administrative fees to revenue tool 300 whereby the referred appointments may be removed from user 105's schedule. Process flow for doctor referral tool 400 is described in more detail below.

Revenue tool 300 may execute specialist referral tool 500, as per block 335. Specialist referral tool 500 may return a list of appointments referred to specialists and associated administrative fees to revenue tool 300 whereby the referred appointments may be removed from user 105's schedule. Process flow for specialist referral tool 500 is described in more detail below.

Revenue tool 300 may execute facility referral tool 600, as per block 340. Facility referral tool 600 may return a list of appointments referred to other doctors and associated administrative fees to revenue tool 300 whereby the referred appointments may be removed from user 105's schedule. Process flow for facility referral tool 600 is described in more detail below.

Revenue tool 300 may execute consultation tool 700, as per block 345. Consultation tool 700 may return a list of consultations referred to other doctors and associated administrative fees to revenue tool 300 whereby the referred appointments may be removed from user 105's schedule. Process flow for consultation tool 700 is described in more detail below.

Revenue tool 300 may utilize the user information, other information from information store 280 and the referred appointments and associated administrative fees to predict the revenue of user 105's schedule, as per block 350. In one embodiment, revenue tool 300 may calculate a predicted revenue for each appointment in the schedule utilizing the patient history, patient insurance information, disease classification codes, procedures associated with the disease classification codes, staff requirements associated with the medical procedures and disease classification codes, medical supply requirements associated with the medical procedures and disease classification codes, time requirements, and respective costs. Process flow continues at block 355.

If revenue tool 300 determines that user 105's schedule matches user 105's preferences, as per block 325, process flow continues at block 355. Revenue tool 300 may determine that the predicted revenue is not greater than the revenue threshold, as per block 355. For example, there may not be enough appointments in user 105's schedule with respective revenue, or appointments with sufficient revenue to exceed the revenue threshold. Revenue tool 300 may identify the low revenue appointments and/or empty time slots in user 105's schedule and utilize doctor referral tool 400, specialist referral tool 500, facility referral tool 600 and/or consultation tool 700 to increase revenue.

Revenue tool 300 may execute doctor referral tool 400, as per block 330. Doctor referral tool 400 may return a list of potential appointments referred from other doctors and associated administrative fees to revenue tool 300. Process flow for doctor referral tool 400 is described in more detail below. Revenue tool 300 may execute specialist referral tool 500, as per block 335. Specialist referral tool 500 may return a list of potential appointments referred from other doctors and associated administrative fees to revenue tool 300. Process flow for specialist referral tool 500 is described in more detail below.

Revenue tool 300 may execute facility referral tool 600, as per block 340. Facility referral tool 600 may return a list of potential appointments referred from other doctors and/or facilities and associated administrative fees to revenue tool 300. Process flow for facility referral tool 600 is described in more detail below. Revenue tool 300 may execute consultation tool 700, as per block 345. Consultation tool 700 may return a list of potential consultations required from other doctors and associated consultation fees to revenue tool 300. Process flow for consultation tool 700 is described in more detail below.

Revenue tool 300 may utilize the user information, other information from information store 280, the referred appointments and associated administrative fees and the consultation appointments and associated consultation fees to predict the potential revenue of user 105's potential schedule, as per block 350. In one embodiment, revenue tool 300 may calculate a predicted revenue for each appointment in the schedule utilizing the patient history, patient insurance information, disease classification codes, procedures associated with the disease classification codes, staff requirements associated with the medical procedures and disease classification codes, medical supply requirements associated with the medical procedures and disease classification codes, time requirements, and respective costs.

If revenue tool 300 determines that the predicted revenue is still not greater than the revenue threshold, as per block 355, revenue tool 300 may repeat the above process flow in an attempt to find new appointments and create a new schedule for user 105 with higher revenue. In one embodiment, if revenue tool 300 determines that the predicted revenue is still not greater than the revenue threshold, but has increased, process flow may continue as per block 360. In another embodiment, revenue tool 300 may refer low revenue appointments to other doctors, specialists, and/or facilities and replace the appointments with higher revenue appointments referred from other doctors, specialists, and/or facilities, to increase revenue.

Revenue tool 300 may determine that the predicted revenue is greater than the revenue threshold, as per block 355. Revenue tool 300 may modify user 105's schedule to include additional appointments and consultations, as per block 360. Process flow may end, as per block 365. Alternatively, process flow may continue back to start block 305 and the process starts anew.

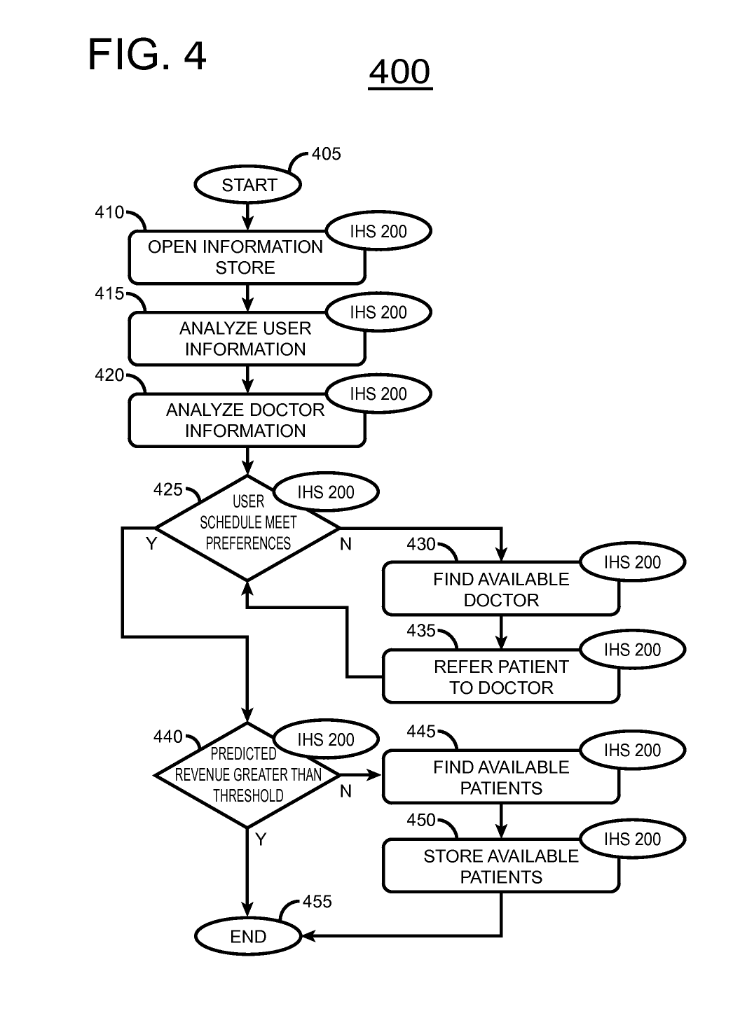

FIG. 4 is a flowchart that shows a representative process flow of a doctor referral tool 400 that executes on IHS 200. Process flow commences when IHS 200 is switched on, as per start block 405. In actual practice, the user may press a button on the user interface to initiate doctor referral tool 400, as shown in one embodiment in FIG. 9. Alternatively, doctor referral tool 400 may be initialized by revenue tool 300. Doctor referral tool 400 may open information store 280 to extract information needed by doctor referral tool 400, as per block 410.

Doctor referral tool 400 may analyze user information stored from information store 280, as per block 415. User information may include information about the particular user 105, but may not be limited to, schedule, proficiencies and preferences. Doctor referral tool 400 may analyze doctor information stored from information store 280, as per block 420. Doctor information may include information about doctors, but may not be limited to, schedule, proficiencies and preferences, respectively.

Doctor referral tool 400 may analyze the user information, doctor information and other information from information store 280 to determine if the doctors are proficient and thereby suitable for a particular appointment, and/or if the user 105 is proficient or suitable for a particular appointment. Doctor referral tool 400 may determine that user 105's schedule does not match user 105's preferences, as per block 425. For example, user 105's schedule may include appointments at times not during user 105's working hours set in user 105's preferences. Doctor referral tool 400 may identify the conflicting appointments in user 105's schedule and ameliorate the conflict.

Doctor referral tool 400 may find an available doctor whose preferences and proficiencies match the appointment from user 105's schedule, as per block 430. Doctor referral tool 400 may refer the patient associated with the appointment, removing the appointment from user 105's schedule and adding the appointment to the particular doctor's schedule, as per block 435. Process flow continues at block 425.

Doctor referral tool 400 may determine that user 105's schedule does meet user 105's preferences, as per block 425. Doctor referral tool 400 may determine that the predicted revenue is not greater than the revenue threshold, as per block 440. Doctor referral tool 400 may find all available patients and their associated appointment times and information, as per block 445. Doctor referral tool 400 may store the available patients and their associated appointments for further analysis by the revenue tool 300, as per block 450. Process flow continues at block 455.

Doctor referral tool 400 may determine that the predicted revenue is greater than the revenue threshold, as per block 440. Process flow may end, as per block 455. Alternatively, process flow may continue back to start block 405 and the process starts anew.

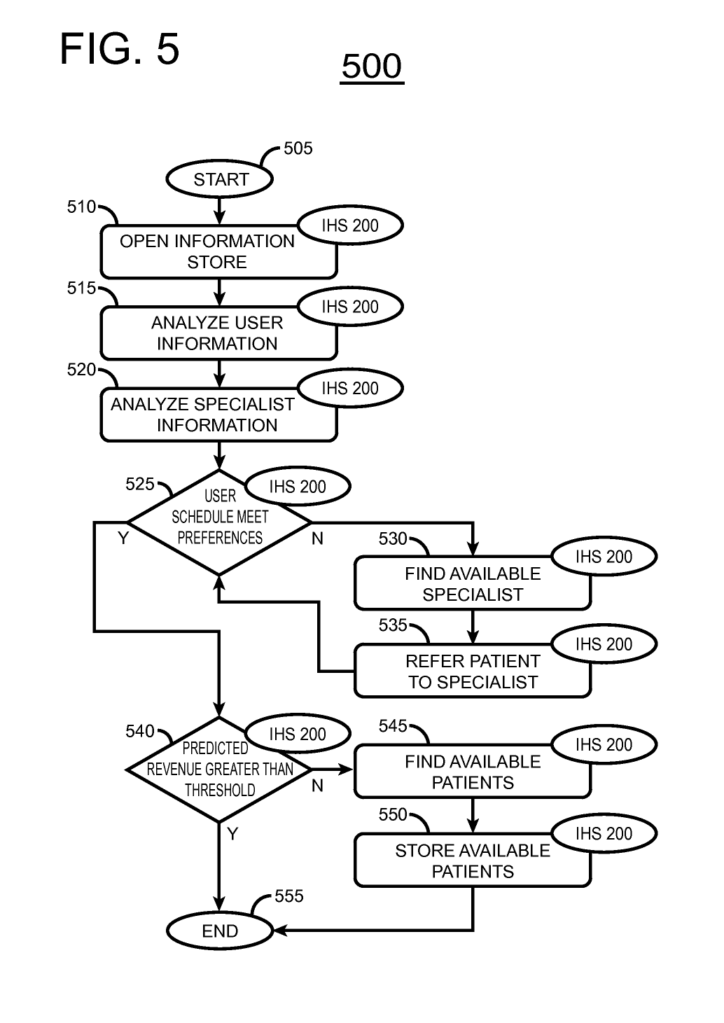

FIG. 5 is a flowchart that shows a representative process flow of a specialist referral tool 500 that executes on IHS 200. Process flow commences when IHS 200 is switched on, as per start block 505. In actual practice, the user may press a button on the user interface to initiate specialist referral tool 500, as shown in one embodiment in FIG. 9. Alternatively, specialist referral tool 500 may be initialized by revenue tool 300. Specialist referral tool 500 may open information store 280 to extract information needed by specialist referral tool 500, as per block 510.

Specialist referral tool 500 may analyze user information stored from information store 280, as per block 515. User information may include information about the particular user 105, but may not be limited to, schedule, proficiencies and preferences. Specialist referral tool 500 may analyze specialist information stored from information store 280, as per block 520. Specialist information may include information about doctors and/or specialists, but may not be limited to, schedule, proficiencies and preferences, respectively. In one embodiment, a specialist may utilize user 105's office for referred appointments. In another embodiment, user 105 may utilize a particular specialist's office for appointments referred from the particular specialist to user 105.

Specialist referral tool 500 may analyze the user information, specialist information and other information from information store 280 to determine if the specialists are proficient and thereby suitable for a particular appointment, and/or if the user 105 is proficient or suitable for a particular appointment. Specialist referral tool 500 may determine that user 105's schedule does not match user 105's preferences, as per block 525. For example, user 105's schedule may include appointments at times not during user 105's working hours set in user 105's preferences. Specialist referral tool 500 may identify the conflicting appointments in user 105's schedule and ameliorate the conflict.

Specialist referral tool 500 may find an available specialist whose preferences and proficiencies match the appointment from user 105's schedule, as per block 530. Specialist referral tool 500 may refer the patient associated with the appointment, removing the appointment from user 105's schedule and adding the appointment to the particular specialist's schedule, as per block 535. In one embodiment, the specialist referral tool 500 may refer the patient associated with the appointment, removing the appointment form user 105's schedule and adding the appointment to the particular specialist's schedule, but keeping the appointment at user 105's office, allowing the specialist to attend to the patient at user 105's office. Process flow continues at block 525.

Specialist referral tool 500 may determine that user 105's schedule does meet user 105's preferences, as per block 525. Specialist referral tool 500 may determine that the predicted revenue is not greater than the revenue threshold, as per block 540. Specialist referral tool 500 may find all available patients and their associated appointment times and information, as per block 545. Specialist referral tool 500 may store the available patients and their associated appointments for further analysis by the revenue tool 300, as per block 550. In one embodiment, user 105 may utilize the referring specialists' office for the respective appointment referred to user 105. Process flow continues at block 555.

Specialist referral tool 500 may determine that the predicted revenue is greater than the revenue threshold, as per block 540. Process flow may end, as per block 555. Alternatively, process flow may continue back to start block 505 and the process starts anew.

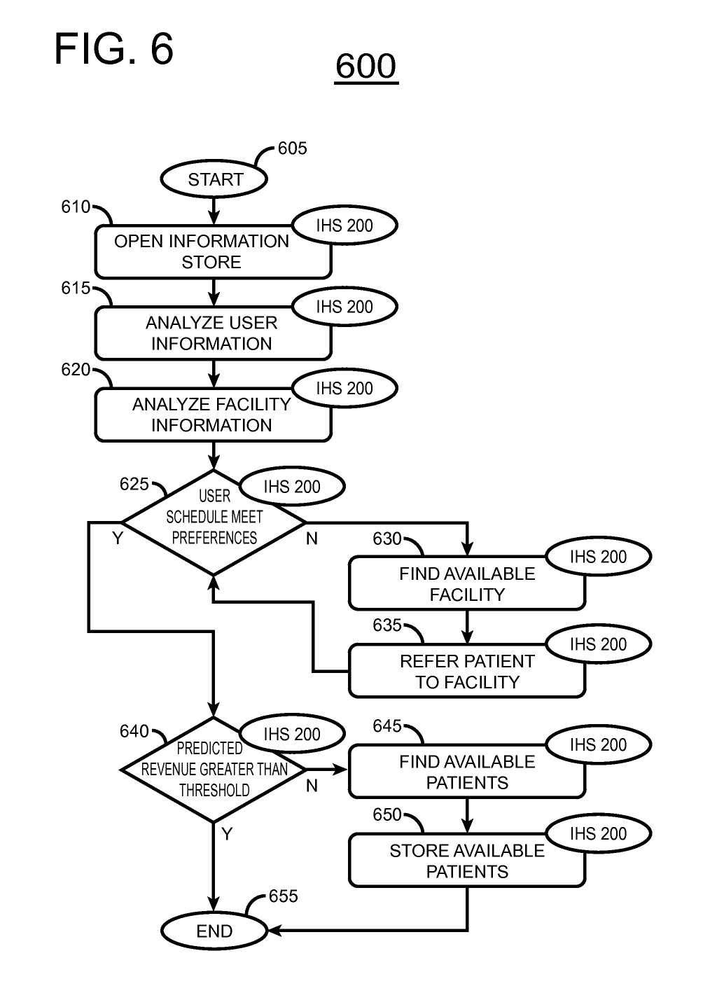

FIG. 6 is a flowchart that shows a representative process flow of a facility referral tool 600 that executes on IHS 200. Process flow commences when IHS 200 is switched on, as per start block 605. In actual practice, the user may press a button on the user interface to initiate facility referral tool 600, as shown in one embodiment in FIG. 9. Alternatively, facility referral tool 600 may be initialized by revenue tool 300. Facility referral tool 600 may open information store 280 to extract information needed by facility referral tool 600, as per block 610.

Facility referral tool 600 may analyze user information stored from information store 280, as per block 615. User information may include information about the particular user 105, but may not be limited to, schedule, proficiencies and preferences. Facility referral tool 600 may analyze facility information stored from information store 280, as per block 620. Facility information may include information about facility equipment, schedule, and proficiency. For example, a facility may include magnetic resonance imaging (MRI) equipment and/or tomography equipment and respective availabilities.

Facility referral tool 600 may analyze the user information, facility information and other information from information store 280 to determine if the facilities are proficient and thereby suitable for a particular appointment, and/or if the user 105 is proficient or suitable for a particular appointment. Facility referral tool 600 may determine that user 105's schedule does not match user 105's preferences, as per block 625. For example, user 105's schedule may include appointments at times not during user 105's working hours set in user 105's preferences. Facility referral tool 600 may identify the conflicting appointments in user 105's schedule and ameliorate the conflict.

Facility referral tool 600 may find an available facility whose preferences and proficiencies match the appointment from user 105's schedule, as per block 630. Facility referral tool 600 may refer the patient associated with the appointment, removing the appointment from user 105's schedule and adding the appointment to the particular facility's schedule, as per block 635. Process flow continues at block 625.

Facility referral tool 600 may determine that user 105's schedule does meet user 105's preferences, as per block 625. Facility referral tool 600 may determine that the predicted revenue is not greater than the revenue threshold, as per block 640. Facility referral tool 600 may find all available patients and their associated appointment times and information, as per block 645. Facility referral tool 600 may store the available patients and their associated appointments for further analysis by the revenue tool 300, as per block 650. Process flow continues at block 655.

Facility referral tool 600 may determine that the predicted revenue is greater than the revenue threshold, as per block 640. Process flow may end, as per block 655. Alternatively, process flow may continue back to start block 605 and the process starts anew.

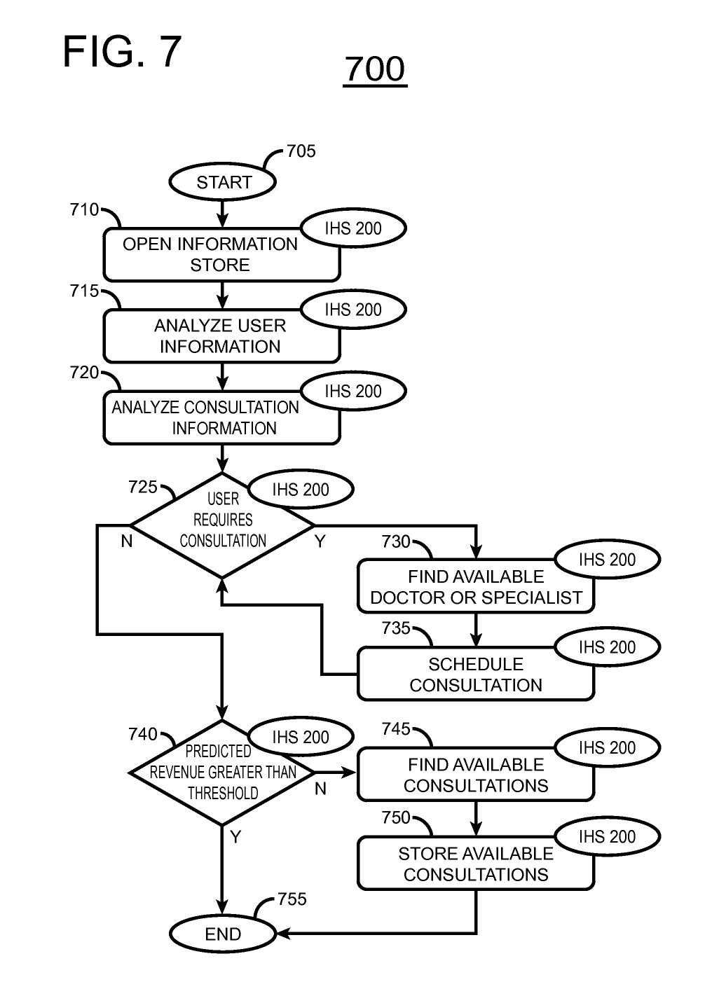

FIG. 7 is a flowchart that shows a representative process flow of a consultation tool 700 that executes on IHS 200. Process flow commences when IHS 200 is switched on, as per start block 705. In actual practice, the user may press a button on the user interface to initiate consultation tool 700, as shown in one embodiment in FIG. 9. Alternatively, consultation tool 700 may be initialized by revenue tool 300. Consultation tool 700 may open information store 280 to extract information needed by consultation tool 700, as per block 710.

Consultation tool 700 may analyze user information stored from information store 280, as per block 715. User information may include information about the particular user 105, but may not be limited to, schedule, proficiencies and preferences. Consultation tool 700 may analyze doctor information stored from information store 280, as per block 720. Doctor information may include information about doctors, but may not be limited to, schedule, proficiencies and preferences, respectively.

Consultation tool 700 may analyze the user information, doctor information and other information from information store 280 to determine if the doctors are proficient and thereby suitable for a particular consultation, and/or if the user 105 is proficient or suitable for a particular consultation. Consultation tool 700 may determine that user 105's schedule does not match user 105's preferences, as per block 725. For example, user 105's schedule may include appointments at times not during user 105's working hours set in user 105's preferences. Consultation tool 700 may identify the conflicting appointments in user 105's schedule and ameliorate the conflict.

Consultation tool 700 may find an available doctor and/or specialist whose preferences and proficiencies match the appointment from user 105's schedule, as per block 730. Consultation tool 700 may refer the doctor and/or specialist associated with the consultation, removing the consultation appointment from user 105's schedule and adding the appointment to the particular doctor's schedule, as per block 735. Process flow continues at block 725.

Consultation tool 700 may determine that user 105's schedule does meet user 105's preferences, as per block 725. Consultation tool 700 may determine that the predicted revenue is not greater than the revenue threshold, as per block 740. Consultation tool 700 may find all available consultations and their associated appointment times and information, as per block 745. Consultation tool 700 may store the available doctors and their associated consultation appointments for further analysis by the revenue tool 300, as per block 750. Process flow continues at block 755.

Consultation tool 700 may determine that the predicted revenue is greater than the revenue threshold, as per block 740. Process flow may end, as per block 755. Alternatively, process flow may continue back to start block 705 and the process starts anew.

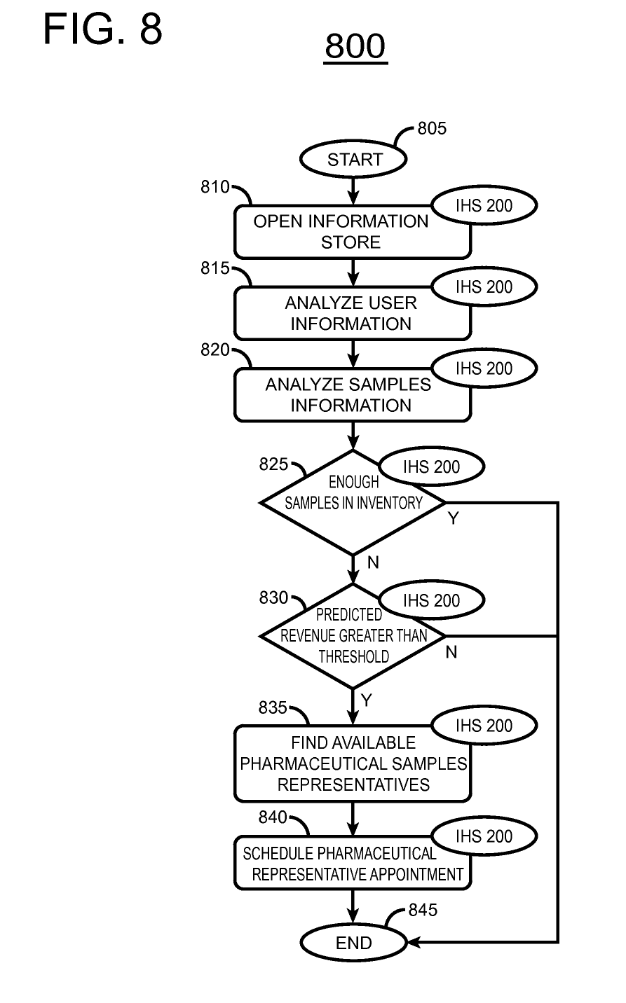

FIG. 8 is a flowchart that shows a representative process flow of a samples tool 800 that executes on IHS 200. Process flow commences when IHS 200 is switched on, as per start block 805. In actual practice, the user may press a button on the user interface to initiate samples tool 800, as shown in one embodiment in FIG. 9. Samples tool 800 may open information store 280 to extract information needed by samples tool 800, as per block 810.

Samples tool 800 may analyze user information stored from information store 280, as per block 815. User information may include information about the particular user 105, but may not be limited to, samples inventory, schedule, proficiencies and preferences. Samples tool 800 may analyze samples information stored from information store 280, as per block 820. Samples information may include information about pharmaceutical samples, but may not be limited to, pharmaceutical representative schedules, sample efficacies and sample availability, respectively.

Samples tool 800 may analyze the user information, samples information and other information from information store 280 to determine if the samples are required and if an appointment with a pharmaceutical samples representative needs to be set. Samples tool 800 may determine that user 105 has enough pharmaceutical samples in user 105's samples inventory, as per block 825. Process flow continues at block 845.

Samples tool 800 may determine that user 105 does not have enough pharmaceutical samples in user 105's samples inventory, as per block 825. Samples tool 800 may determine that the predicted revenue is not greater than the revenue threshold, as per block 830. Process flow continues at block 845.

Samples tool 800 may determine that the predicted revenue is greater than the revenue threshold, as per block 830. Samples tool 800 may find an available pharmaceutical samples representative whose schedule and sample efficacies match the samples required by user 105, as per block 835. Samples tool 800 may schedule the pharmaceutical representative associated with the required samples, adding the appointment to user 105's schedule and adding the appointment to the particular pharmaceutical representative's schedule, as per block 840. Process flow may end, as per block 845. Alternatively, process flow may continue back to start block 805 and the process starts anew.

FIG. 9 is a representation of one embodiment of the disclosed peer-to-peer management and productivity system showing user interface 900 on a display 905. In one embodiment, display 905 may be a touch screen device. User 105 may select predict revenue button 910. Selecting predict revenue button 910 may execute revenue tool 300 and change display 905 to display projected revenue 1100 as shown in FIG. 11.

User 105 may select actual revenue button 915. Selecting actual revenue button 915 may execute the learning element 1000 of the revenue tool 300 and change display 905 to display fields where actual revenue from past appointments may be input (not shown).

User 105 may select refer patient button 920. In one embodiment, selecting refer patient button 920 may execute doctor referral tool 400, specialist referral tool 500 and/or facility referral tool 600. In another embodiment, selecting refer patient button 920 may change display 905 to display options allowing user 105 to choose between doctor referral tool 400, specialist referral tool 500 and/or facility referral tool 600. In yet another embodiment, selecting refer patient button 920 may change display 905 to display options that allow user 105 to select a patient and malady and IHS 200 will in response automatically select either doctor referral tool 400, specialist referral tool 500 or facility referral tool 600 and execute the appropriate tool.

User 105 may select check samples button 925. Selecting check samples button 925 may execute samples tool 800 and change display 905 to display fields where user 105's samples inventory may be viewed.

User 105 may select message doctor button 930. Selecting message doctor button 930 may change display 905 to display fields where user 105 may send messages to other doctors, specialists, facilities, pharmaceutical representatives, and more. User 105 may select check messages button 935. Selecting check messages button 935 may change display 905 to display fields containing messages received from other doctors, specialists, facilities, pharmaceutical representatives, and more.

User 105 may select check schedule button 940. Selecting check schedule 940 may change display 905 to display fields containing user 105's schedule. User 105 may choose to view the schedule on an appointment-by-appointment basis, 15 minute intervals, hourly, weekly, monthly basis, or more. User 105 may select edit user preferences button 945. Selecting edit user preferences button 945 may change display 905 to display fields containing user 105's preferences and proficiencies, allowing user 105 to add, modify, or remove the existing preferences and proficiencies.

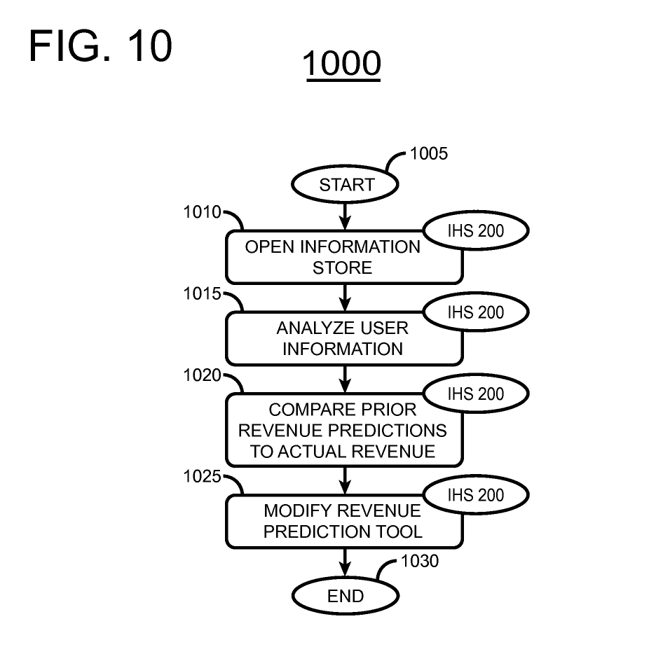

FIG. 10 is a flowchart that shows a representative process flow of a learning element 1000 of revenue tool 300 that executes on IHS 200. Process flow commences when IHS 200 is switched on, as per start block 1005. In actual practice, the user may press a button on the user interface to initiate the learning element 1000 of revenue tool 300, as shown in one embodiment in FIG. 9. Learning element 1000 of revenue tool 300 may open information store 280 to extract information needed by the learning element 1000 of revenue tool 300, as per block 1010. Learning element 1000 of revenue tool 300 may analyze user information stored from information store 280, as per block 1015. User information may include information about the particular user 105, but may not be limited to, schedule, proficiencies and preferences. The schedule may include appointments and bookings for particular times on particular days.

In one embodiment, the appointments may include information associated with the appointment. Schedule information may include appointment times, appointment durations, patient identifying information, patient history, patient insurance information, disease classification codes and medical procedures associated with the disease classification codes. Proficiencies may include disease classification codes with which user 105 is proficient, medical procedures associated with the disease classification codes with which user 105 is proficient as well as known languages, and specialties of user 105. Preferences may include preferred working hours, additional working hours, hours unable to work, accepted insurances and revenue threshold. Schedule information may also include prior revenue predictions and actual revenue.

Learning element 1000 of revenue tool 300 may utilize the user information and other information from information store 280 to compare the prior predicted revenue of user 105's schedule to the actual revenue of user 105's schedule, as per block 1020. Learning element 1000 of revenue tool 300 may modify revenue tool 300 by modifying the relative importance of information utilized by revenue tool 300 to predict revenue, so that the predicted revenue of prior revenue predictions more closely matches the actual revenue, as per block 1025.

For example, learning element 1000 of revenue tool 300 may modify the weights of importance of the patient history, patient insurance information, disease classification codes, procedures associated with the disease classification codes, staff requirements associated with the medical procedures and disease classification codes, medical supply requirements associated with the medical procedures and disease classification codes, time requirements, and respective costs. Process flow may end, as per block 1030. Alternatively, process flow may continue back to start block 1005 and the process starts anew.

FIG. 11 is a block diagram showing one embodiment of the disclosed peer-to-peer management and productivity system including predicted revenue output of a particular user over a temporal span 1100. In one embodiment, the predicted revenue output of a particular user over a temporal span 1100 is displayed in a table with a time 1105 column and appointments—predicted revenue 1110 column. In this exemplary embodiment, the time divisions in time 1105 column are shown in 15 minute intervals from 9:00 through 11:00. Predicted revenue is displayed in the appointments—predicted revenue 1110 column. For example, appointment 1115 generates a predicted revenue of $1200 and spans from 9:00 to 9:30.

Appointment 1120 may be a referred appointment, only generating a revenue of $120 from an administrative fee, spanning from 9:15 until 9:45, but user 150 is does not attend appointment 1120. Appointment 1125 generates a predicted revenue of $400 and may be a consultation between user 150 and another doctor spanning from 9:30 until 9:45. Appointment 1130 generates a predicted revenue of $800 and spans from 9:30 to 10:00. Appointment 1135 generates a predicted revenue of $110 and spans from 10:15 until 10:45. User 150 may have set in the user 150 preferences that from 10:15 until 10:45 user 150 requires a break and will not work. The predicted revenue of $110 from appointment 1135 may be an administrative fee from referring the patient associated with appointment 1135 to another doctor and/or specialist and/or facility.

Appointment 1140 generates a predicted revenue of $1000 and spans from 10:45 until 11:15. Appointment 1140 may be a referral from another doctor and/or specialist and/or facility and generates a predicted revenue of only $1000 after the administrative fee. For one embodiment of the disclosed peer to peer management and productivity system including predicted revenue output of a particular user over a temporal span 1100, the predicted total revenue 1145 is displayed in total predicted revenue field 1150 as $3630.

An honor rating system may be utilized to determine the administrative fee rates between doctors. In one embodiment, an administrative fee may charged to the user based upon the number of times they have been “clicked through” and/or accessed in the system. For example, a patient may search for a doctor and “click through” user 105's information. User 105 may pay an administrative fee to a service provider of the peer-to-peer networking system based upon the number of “click through” events associated with user 105's information. In another embodiment, user 105 may associate a “button” that links to user 105's information in the peer-to-peer networking system on a social-media type webpage and/or any other webpage. User 105 may be charged and administrative fee for an amount “click through” events, i.e. when a person clicks on the “button” to thereby access user 105's information on the peer-to-peer networking system. In other embodiments, these “click through” events may be also when patients view the schedules or available appointments of a particular user 105 in the peer-to-peer networking system. In one embodiment, doctor performance may be rated with the following activities:

1. Complete and submit daily/weekly/monthly survey. Could be questions about trending data or peer advice as needed to improve the utility and service of the network.

2. Complete and submit requested feedback about peer response and follow up related to peer to peer (P2P) activities, including accuracy of registered information, peer's prompt communication about referred patient condition/treatment, patient's service experience and satisfaction with peer.

3. Confirmation of phone call follow up with patient within 15 hrs of online apt set up on behalf of a P2P-linked peer. System will receive confirmation when appointment status changes from “Tentative” to “Confirmed” status. System will provide a reminder at the start of the work day within 15 hrs window. Also list as to-do on the dashboard.

The honor system may use the above criteria to determine weights for the doctors participating the P2P system.

Honor Rating System Weights:

Performance on each of the above may be measured monthly and scored on a 1-5 scale Honor Rating System as described below, 5 being the highest score. Score may be measured for each activity and then averaged for the 3 activities as Royalty score for any given month.

1) will count as:

100% responded/answered—Score 5

80-99% responded/answered—Score 4

60-79% responded/answered—Score 3

40-59% responded/answered—Score 2

20-39% responded/answered—Score 1

0-19% responded/answered—No Score

2) will count as:
P2P peer rating 5—Score 5
P2P peer rating 4-4.9—Score 4
P2P peer rating 3-3.9—Score 3
P2P peer rating 2-2.9—Score 2
P2P peer rating 1-1.9—Score 1

3) will count as:

100% appointment confirmed within 15 hrs—Score 5

80-99% appointment confirmed within 15 hrs—Score 4

60-79% appointment confirmed within 15 hrs—Score 3

40-59% appointment confirmed within 15 hrs—Score 2

20-39% appointment confirmed within 15 hrs—Score 1

0-19% appointment confirmed within 15 hrs—No Score

In one embodiment, royalty payments may also be utilized with the honor score. Sign up peer by sending them a sign up link—Royalty payment of 20% of subscription fees on registration of every invited peer registration. Royalty payment starts after 60 days of peer registration as a subscribing member. Sign up royalty is paid as long as the peer signed up remains a subscribing member.

Royalties may be paid per active P2P link measured on a monthly basis. 40% of monthly subscription per active P2P link per month on an average score of 5 on the Honor Rating System described below. 30% paid on score of 4, 20% paid on score of 3, 10% paid on score of 2, and 0% paid on a score of 1.

Active P2P link is defined by doing one or more of the following:

A. Be a subscribing member for at least 60 days with a completed registration.

B. Publish (serve) your available appointments on the network everyday.

C. Setup patient(s) appointments on peer's Calendar using peer's published slots.

As will be appreciated by one skilled in the art, aspects of the disclosed methodology may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the FIGS. 3, 4, 5, 6, 7, 8 and 10 flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart of FIGS. 3, 4, 5, 6, 7, 8 and 10 and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart of FIGS. 3, 4, 5, 6, 7, 8 and 10 described above.

The flowchart of FIGS. 3, 4, 5, 6, 7, 8 and 10 illustrate the architecture, functionality, and operation of possible implementations of systems, methods and computer program products that perform analysis in accordance with various embodiments of the present invention. In this regard, each block in the flowcharts of FIGS. 3, 4, 5, 6, 7, 8 and 10 may represent a module, segment, or portion of code, which comprises one or more executable instructions for implementing the specified logical function(s). It should also be noted that, in some alternative implementations, the functions noted in the block may occur out of the order noted in FIGS. 3, 4, 5, 6, 7, 8 and 10. For example, two blocks shown in succession may, in fact, be executed substantially concurrently, or the blocks may sometimes be executed in the reverse order, depending upon the functionality involved. It will also be noted that each block of FIGS. 3, 4, 5, 6, 7, 8 and 10 and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
receiving, by a revenue tool of an information handling system (IHS), input information including a current appointment schedule of a particular user, proficiencies of the particular user, and preferences of the particular user from an information store;
determining, by the revenue tool of the IHS, a predicted revenue for the particular user for a predetermined period of time in response to the input information;
testing to determine, by the revenue tool of the IHS, if the predicted revenue associated with the current schedule meets a target revenue threshold;
accessing, by the revenue tool of the IHS, alternative tools that potentially increase the predicted revenue of the particular user, the alternative tools being accessed if the predicted revenue associated with the current schedule does not meet the target revenue threshold;
transmitting, by the alternative tools, optional scheduling information to the revenue tool, the optional scheduling information including scheduling options;
determining, by the revenue tool of the IHS, revenue associated with each of the scheduling options of the option scheduling information;
modifying, by the revenue tool of the IHS, the current appointment schedule of the particular user in response to the option scheduling information if the scheduling options associated therewith provide increased revenue, thus providing a modified appointment schedule; and
displaying, by the revenue tool of the IHS, the modified appointment schedule of the particular user in response to the modifying step.

2. The method of claim 1, wherein the modifying step determines an increased predicted revenue that is the maximum predicted revenue for the particular user for the predetermined period of time.

3. The method of claim 1, wherein the revenue tool provides additional hours to the schedule of the particular user if the revenue threshold is not met during base hours.

4. The method of claim 1, wherein the proficiencies of the particular user include disease classification codes and procedures associated with the disease classification codes.

5. The method of claim 1, wherein the alternative tools include a doctor referral tool, a specialist referral tool, a facility referral tool and a consultation tool.

6. The method of claim 5, wherein the doctor referral tool provides an additional appointment for the particular user for the predetermined period of time, the particular user being a referral receiving doctor.

7. The method of claim 5, wherein the doctor referral tool provides an additional appointment for a user other than the particular user, the particular user being a referral supplying doctor.

8. The method of claim 5, wherein the specialist referral tool provides an additional appointment for the particular user for the predetermined period of time, the particular user being a referral receiving specialist.

9. The method of claim 5, wherein the specialist referral tool provides an additional appointment for a user other than the particular user for the predetermined period of time, the particular user being a referral supplying doctor.

10. The method of claim 5, wherein the facility referral tool provides an additional appointment for the particular user for the predetermined period of time, the particular user being a referral receiving user with matching facilities.

11. The method of claim 5, wherein the facility referral tool provides an additional appointment for a user other than the particular user for the predetermined period of time, the particular user being a referral supplying doctor.

12. The method of claim 5, wherein the consultation tool provides an additional appointment for the particular user for the predetermined period of time, the particular user being a consultation receiving doctor.

13. The method of claim 5, wherein the consultation tool provides an additional appointment for a user other than the particular user for the predetermined period of time, the particular user being a consultation supplying doctor.

14. The method of claim 1, further comprising:
determining, by a samples tool of the IHS, an amount of samples in inventory; and
requesting, by the samples tool of the IHS, additional samples if the amount of samples in inventory is insufficient.

15. The method of claim 15, wherein the samples in inventory are pharmaceutical samples.

16. An information handling system (IHS), comprising:
a processor;
a memory, coupled to the processor, the memory being configured with a revenue tool to:
receive input information including a current appointment schedule of a particular user, proficiencies of the particular user, and preferences of the particular user from an information store;
determine a predicted revenue for the particular user for a predetermined period of time in response to the input information;
test to determine if the predicted revenue associated with the current schedule meets a target revenue threshold;
access alternative tools in the memory that potentially increase the predicted revenue of the particular user, the alternative tools being accessed if the predicted revenue associated with the current schedule does not meet the target revenue threshold;
wherein the alternative tools transmit optional scheduling information to the revenue tool, the optional scheduling information including scheduling options;
wherein the revenue tool determines revenue associated with each of the scheduling options of the option scheduling information;
wherein the revenue tool modifies the current appointment schedule of the particular user in response to the option scheduling information if the scheduling options associated therewith provide increased revenue, thus providing a modified appointment schedule; and
wherein the revenue tool displays the modified appointment schedule of the particular user in response to the modifying the current appointment schedule.

17. The IHS of claim 16, wherein the revenue tool determines an increased predicted revenue that is the maximum predicted revenue for the particular user for the predetermined period of time.

18. The IHS of claim 16, wherein the revenue tool provides additional hours to the schedule of the particular user if the revenue threshold is not met during base hours.

19. The IHS of claim 16, wherein the proficiencies of the particular user include disease classification codes and procedures associated with the disease classification codes.

20. The IHS of claim 16, wherein the alternative tools include a doctor referral tool, a specialist referral tool, a facility referral tool and a consultation tool.

21. A revenue tool computer program product, comprising:
a non-transitory computer readable storage medium;
first instructions that receive input information including a current appointment schedule of a particular user, proficiencies of the particular user, and preferences of the particular user from an information store;
second instructions that determine a predictive revenue for the particular user for a predetermined period of time in response to the input information;
third instructions that determine if the predicted revenue associated with the current schedule meets a target revenue threshold;
fourth instructions that access alternative tools that potentially increase the predicted revenue of the particular user, the alternative tools being accessed if the predicted revenue associated with the current schedule does not meet the target revenue threshold;
fifth instructions that transmit optional scheduling information to the revenue tool, the optional scheduling information including scheduling options;
sixth instructions that determine revenue associated with each of the scheduling options of the options scheduling information;
seventh instructions that modify the current appointment schedule of the particular user in response to the option scheduling information if the scheduling options associated therewith provide increased revenue, thus providing a modified appointment schedule;
eighth instructions that display the modified appointment schedule of the particular user in response to modifying the current appointment schedule;
wherein the first, second, third, fourth, fifth, sixth, seventh and eighth instructions are stored on the non-transitory computer readable storage medium.
